(19) United States
(12) Patent Application Publication
(10) Pub. No.: US 2003/0087739 A1
(43) Pub. Date: May 8, 2003

(54) Methods and systems for constructing multiwall corrugated container blanks having body portions and flap portions with different wall thicknesses

(76) Inventors: John R. Hagemann, Marion, IA (US); John C. Walker, Grafton, WI (US); Guy T. Robertshaw, Marion, IA (US); Michael J. Eaton, Longview, WA (US)

Correspondence Address: PERKINS COIE LLP, PATENT-SEA, P.O. BOX 1247, SEATTLE, WA, 98111-1247, US

(21) Appl. No.: 10/172,815

(22) Filed: Jun. 14, 2002

Related U.S. Application Data
(60) Provisional application No. 60/336,925, filed on Nov. 8, 2001.

(51) Int. Cl. B31B 49/00

(52) U.S. Cl. 493/51

(57) ABSTRACT

Methods and systems for constructing multiwall corrugated container blanks having body portions and flap portions of different wall thickness. In one embodiment, the methods and systems are usable for constructing a multiwall corrugated container blank having a triple wall body portion and double wall flap portions with a score line between each flap portion and the body portion to make subsequent folding of the flaps easier. In one aspect of this embodiment, the system includes a slitter/scorer aligner operably connected to a slitter/scorer. The slitter/scorer aligner determines a location of an edge of the body portion and transmits this location information to the slitter/scorer to position a scoring system and a slitting system. The slitter/scorer aligner also stabilizes the multiwall corrugated container blank as it moves between the slitter/scorer aligner and the slitter/scorer. Using data provided by the slitter/scorer aligner, the scoring system scores the blank adjacent to the triple wall body portion and the slitting system slits the blank to a selected width.

### CROSS-REFERENCE TO RELATED APPLICATION

This application claims the benefit of U.S. Provisional Patent Application Serial No. 60/336,925, filed Nov. 8, 2001, currently pending and incorporated herein in its entirety by reference.

### TECHNICAL FIELD

This invention relates generally to corrugated containers and, more particularly, to constructing blanks for multiwall corrugated containers having body portions and flap portions with different wall thicknesses.

### BACKGROUND

Corrugated containers for shipping and storing of goods and materials are well known. A common corrugated container shape is the four-sided box, having four rectangular side panels and top and bottom closures. The bottom closure is typically formed by flaps that extend from the side panels and are folded inward so that they overlap to create a composite bottom panel. These flaps can be stapled or bonded together to secure the bottom closure. A separate top closure can be provided with the four-sided box; however, it is more common for the top closure to be integrally formed in the same manner as the bottom closure, i.e., by overlapping flaps that extend inward from the respective side panels.

Corrugated containers are usually made from a single “blank.” A blank is a flat piece of corrugated material that is die-cut in an appropriate flat pattern so that it can be erected into a container shape by a sequence of folding and bonding steps. A wide selection of corrugated materials exists for constructing container blanks. These include single wall, double wall, and triple wall corrugated board. Single wall corrugated board is made by bonding a corrugated paper “medium” between two interposing flat paper “liners.” Double wall corrugated board has three flat paper liners and two corrugated paper mediums bonded together in an alternating flat-corrugated-flat-corrugated-flat arrangement. Accordingly, triple wall corrugated board is double wall corrugated board with an additional corrugated paper medium and flat paper liner bonded to it to maintain the appropriate alternating sequence. The decision to use single, double, or triple wall corrugated board will usually depend on the strength requirements of the finished corrugated container.

Large corrugated containers for holding bulk materials are commonly referred to as “bulk bins.” Bulk bins usually have significant strength requirements that dictate construction from double or triple wall corrugated board. Conventional triple wall bulk bins are accordingly constructed from triple wall blanks so that the side panels and top and bottom flaps are all triple-walled. One shortcoming associated with conventional triple wall bulk bins such as these is that the top and bottom flaps are difficult to fold inward for closure because of the substantial material thickness along the fold line. To overcome this shortcoming, some triple wall bulk bin blanks have a channel routed in them along this fold line to remove material and make folding easier. This routing operation is done offline from the main blank manufacturing sequence after the basic blank has been constructed, and as a result adds cost to the overall manufacturing process.

A further shortcoming associated with conventional triple wall bulk bins is that while the side panels of these containers require the added strength of triple walls, the top and bottom flaps usually do not. Consequently, the use of triple walls on the top and bottom flaps results in a waste of corrugated material. To overcome this shortcoming, triple wall bulk bin blanks have been manufactured with triple walls only on the side panels and not on the top and bottom flaps. Manufacturing triple wall bulk bin blanks such as these typically requires implementing two separate manufacturing sequences, a sequence being a series of manufacturing processes in a single production line. For example, a first sequence produces a double wall bulk bin blank using a conventional double wall blank manufacturing process. The double wall blank is then taken off-line to a second sequence where a narrower corrugated board is bonded to its midsection to create the triple wall side panels. The use of two separate manufacturing sequences to produce triple wall bulk bin blanks in this manner adds cost to the overall manufacturing process because of the time and effort required to transfer the double wall blank from the first sequence to the second.

In light of the shortcomings associated with conventional triple wall bulk bins having triple wall flaps, and in light of the shortcomings associated with conventional methods for manufacturing bulk bin blanks with triple wall side panels and double wall flaps, a method for efficiently manufacturing bulk bin blanks with triple wall side panels and double wall flaps would be desirable.

### SUMMARY

Methods and systems are described for constructing multiwall corrugated container blanks having body portions and flap portions with different wall thicknesses. In one embodiment, the methods and systems are usable for constructing a multiwall corrugated container blank having a triple wall body portion and double wall flap portions with a score line between each flap portion and the body portion to make subsequent folding of the flaps easier. In one aspect of this embodiment, the method is a sequentially continuous automated process that includes producing a first web having a first width, producing a second web having a second width greater than the first width, bonding the first web to the second web to at least partially define the body portion and the flap portion of the multiwall corrugated container blank, determining a location of at least one edge of the first web, positioning a male score tool and a cooperating female score tool adjacent to at least one edge of the first web based on the determined location, and scoring the second web adjacent to at least one edge of the first web with the positioned male and female score tools without scoring the first web.

In another embodiment, the system includes a first single face corrugator for producing a first web having a first width, a second single face corrugator for producing a second web having a second width greater than the first width, and a glue machine for receiving the first web from the first single face corrugator and the second web from the second single face corrugator and bonding the first web to the second web to at least partially define the body portion and the flap portions of the multiwall corrugated container blank. The system of this embodiment further includes an alignment system for receiving the bonded first and second web from the glue machine and determining the location of at least one edge of the first web, and a scoring system having at least one male score tool and at least one cooperating female score tool, the scoring system being operably connected to the alignment system for receiving the bonded first and second webs and positioning the male and female score tools adjacent to at least one edge of the first web and scoring the second web adjacent to the first web.

### BRIEF DESCRIPTION OF THE DRAWINGS

FIG. 1 is an isometric view of a multiwall corrugated container having a body portion and flap portions with different wall thicknesses in accordance with an embodiment of the invention.

FIG. 2 is a partially cut-away isometric view of a multiwall corrugated container blank usable for making the multiwall corrugated container of FIG. 1 in accordance with an embodiment of the invention.

FIG. 3 is a schematic diagram of a corrugated container blank manufacturing system usable for manufacturing the multiwall corrugated container blank of FIG. 2 in accordance with an embodiment of the invention.

FIG. 4 is a partially schematic isometric view of a slitter/scorer aligner and a slitter/scorer of the manufacturing system of FIG. 3 in accordance with an embodiment of the invention.

FIG. 5 is an enlarged front cross-sectional view of cooperating male and female score tools taken substantially along line 5-5 of FIG. 4 in accordance with an embodiment of the invention.

### DETAILED DESCRIPTION

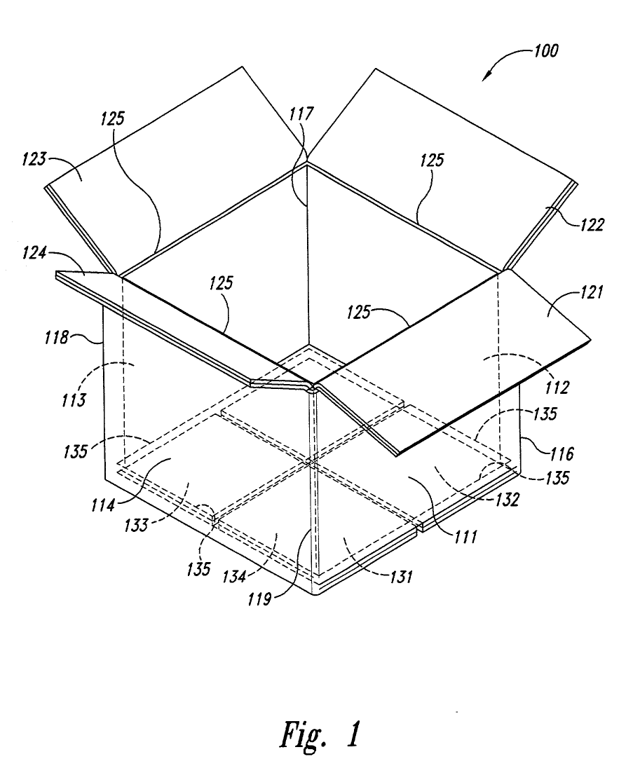

The present disclosure describes multiwall corrugated containers having body portions and flap portions with different wall thicknesses. The present disclosure further describes methods and systems for making blanks for multiwall corrugated containers having body portions and flap portions with different wall thicknesses. Many specific details of certain embodiments of the invention are set forth in the following description and in FIGS. 1-5 to provide a thorough understanding of these embodiments. One skilled in the relevant art, however, will understand that the present invention may have additional embodiments, or that the invention may be practiced without several of the details described below. In other instances, structures and functions well known to those of ordinary skill in the art have not been shown or described in detail here to avoid unnecessarily obscuring the description of the embodiments of the invention.

FIG. 1 is an isometric view of a multiwall corrugated container 100 having a body portion and flap portions with different wall thicknesses in accordance with an embodiment of the invention. In one aspect of this embodiment, the multiwall corrugated container 100 (“container 100”) includes four rectangular triple wall side panels 111-114 extending perpendicularly between vertical fold lines 116-119. In another aspect of this embodiment, the container 100 further includes four rectangular double wall top flaps 121-124 foldably extending from the side panels 111-114, respectively, along horizontal top score lines 125. Double wall bottom flaps 131-134, which are generally similar to the top flaps 121-124, foldably extend from the side panels 111-114, respectively, along horizontal bottom score lines 135.

The bottom flaps 131-134 are shown in a closed configuration in FIG. 1 for purposes of illustration. The bottom flaps 131-134 are closed by folding any two opposing bottom flaps to an inwardly horizontal position and then folding the remaining two bottom flaps to an inwardly horizontal position so as to overlap the first two bottom flaps. The bottom flaps can then be bonded together (for example, by stapling or gluing) if desired to secure the bottom closure of the container 100. Alternatively, the bottom flaps may be folded inwardly and overlapped in an alternating pattern to interlock the bottom flaps. In this interlocked configuration, bonding the bottom flaps together may not be required to secure the bottom closure. The top flaps 121-124 can be closed in a generally similar manner as the bottom flaps 131-134.

Although the container 100 of the illustrated embodiment has triple wall side panels and double wall flaps, in other embodiments, multiwall corrugated containers in accordance with the present invention can alternatively have double wall side panels and single wall flaps. In yet other embodiments, yet other multiwall corrugated containers having side panels and flaps of yet other thicknesses will also fall within the scope of the present disclosure. Further, although the container 100 of the illustrated embodiment is a four-sided box, the methods and systems disclosed herein are equally applicable to other types of containers having other numbers of sides in other configurations. For example, in other embodiments, the methods and systems can be used to construct blanks for an octagonal box or for a triangular box. As will be apparent to those of ordinary skill in the relevant art, the methods and systems disclosed are usable for a wide range of corrugated container blanks in addition to the representative embodiments provided here for illustration.

Large quantities of wet or dry bulk materials can be shipped and stored in the container 100 in accordance with the present invention. When holding liquids, a plastic liner (not shown) conforming to the inner shape of the container 100 can be used to seal the container. In this embodiment, a drain spout (not shown) can be integrally attached to the liner toward the bottom portion of the container 100 for dispensing the liquid contents. A suitable aperture (also not shown) can be provided in a side panel of the container 100 to support the spout in an accessible position.

One feature of the corrugated container 100 of the illustrated embodiment is that it has triple wall side panels 111-114 and double wall top and bottom flaps 121-124 and 131-134, respectively. A further feature of the corrugated container 100 is that it has top and bottom score lines 125 and 135 between the side panels 111-114 and the top and bottom flaps 121-124 and 131-134, respectively. An advantage of these features is that the corrugated container 100 provides the required strength in the side panels 111-114 for carrying bulk materials and conserves material in the top and bottom flaps 121-124 and 131-134, respectively, which also makes for easy folding when closing these flaps.

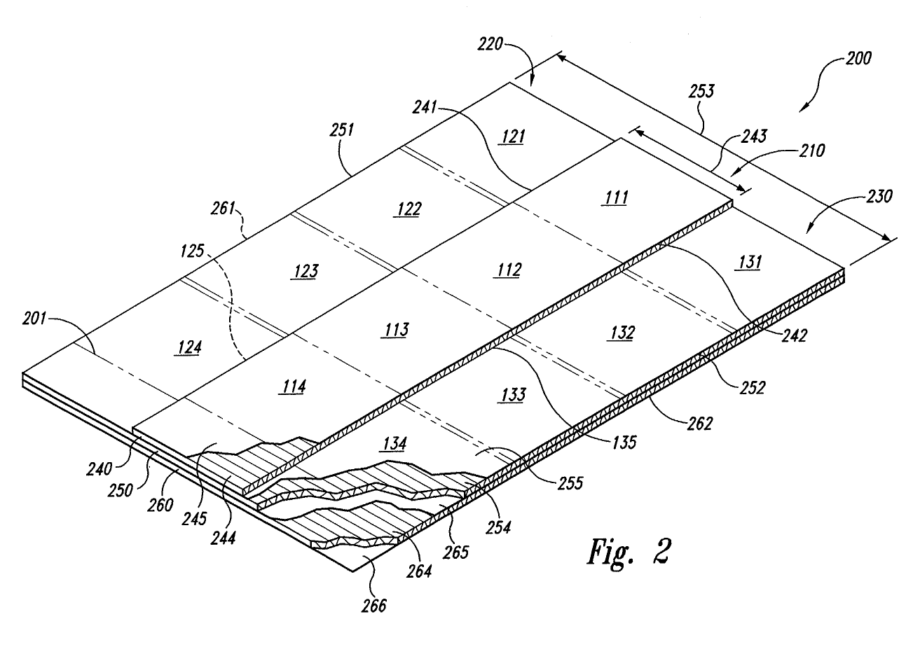

FIG. 2 is a partially cut-away isometric view of a multiwall corrugated container blank 200 usable for making the container 100 of FIG. 1 in accordance with an embodiment of the invention. A flat pattern 201 is superimposed on the blank 200 to orient the reader as to the relationship between the blank 200 and corresponding elements of the container 100. In one aspect of this embodiment, the blank 200 includes a triple wall body portion 210, a double wall top flap portion 220, and a double wall bottom flap portion 230. As shown by the flat pattern 201, the side panels 111-113 of the container 100 will be formed from the triple wall body portion 210, the top flaps 121-124 will be formed from the double wall top flap portion 220, and the bottom flaps 131-134 will accordingly be formed from the double wall bottom flap portion 230. In an alternate embodiment of the blank 200 in accordance with the present invention, the body portion 210 can be double wall and the top and bottom flap portions 220 and 230, respectively, can be single wall. In yet other embodiments, the body portion 210 and the top and bottom flap portions 220 and 230, respectively, can have yet other wall thicknesses so long as the thickness of the body portion is different than the thickness of either the bottom or top flap portions.

In another aspect of this embodiment, the blank 200 includes a first web 240 bonded to a second web 250 that in turn is bonded to a third web 260. The first web 240 has a first left edge 241 offset from a parallel first right edge 242 to define a first width 243. The first web 240 of the illustrated embodiment is a single face web having one side of a corrugated first medium 244 bonded to a flat first paper liner 245. The opposite side of the corrugated first medium 244 is bonded to the second web 250. The second web 250 is wider than the first web 240 and has a second left edge 251 offset from a parallel second right edge 252 to define a second width 253. The second web 250 of the illustrated embodiment is a single face web having one side of a corrugated second medium 254 bonded to a second flat liner 255. The opposite side of the corrugated second medium 254 is bonded to the third web 260. The third web 260 is at least approximately the same width as the second web 250 and has a third left edge 261 offset from a parallel third right edge 262 to define the second width 253. The third web 260 of the illustrated embodiment is also a single face web having one side of a corrugated third medium 264 bonded to a third flat liner 265. The opposite side of the corrugated third medium 264 is bonded to a fourth liner 266.

In another aspect of this embodiment, the blank 200 includes the top score lines 125 adjacent to the first left edge 241 and the bottom score lines 135 adjacent to the first right edge 242, to facilitate folding the top and bottom flaps 121-124 and 131-134, respectively (FIG. 1). For ease of reference, the top score lines 125 will collectively be referred to herein as the top score line 125, and the bottom score lines 135 will collectively be referred to herein as the bottom score line 135. In one embodiment, the top and bottom score lines 125 and 135 are up to about 0.25 inch from the first left and right edges 241 and 242, respectively. In other embodiments, the top and bottom score lines 125 and 135 can be offset from the first left and right edges 241 and 242, respectively, by other distances.

A number of advantages are associated with using the blank 200 to form the container 100 in accordance with the present invention. For example, the blank 200 provides a triple wall body portion for holding bulk materials while providing double wall top and bottom flap portions for ease of folding. Folding is further eased because the second and third webs 250 and 260 are compressed along the top and bottom score lines 125 and 135 to reduce bending resistance. In addition, the blank 200 also uses less raw material than conventional triple wall corrugated container blanks having triple wall flap portions.

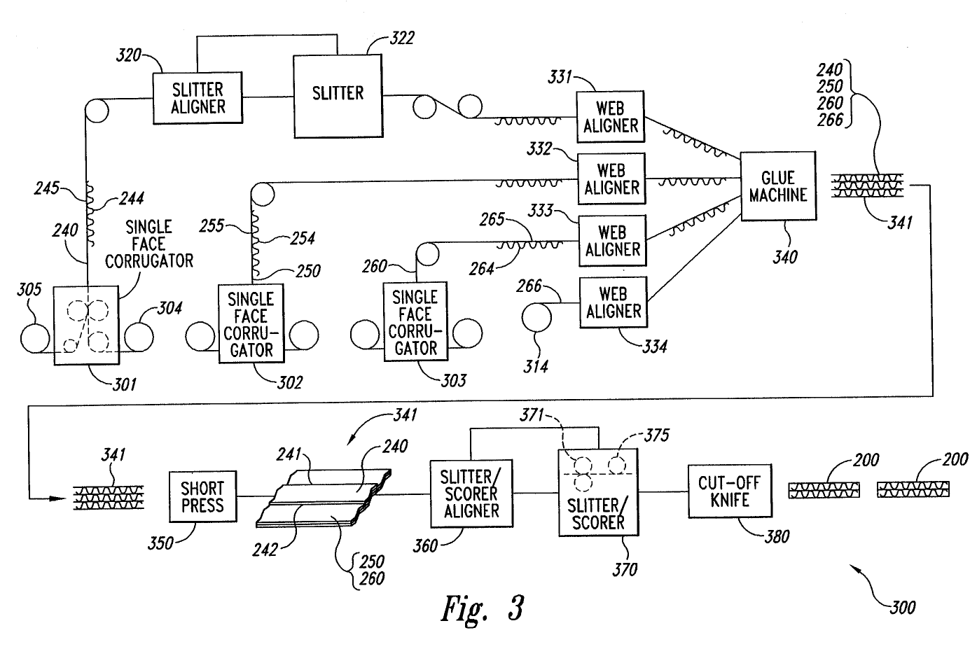

FIG. 3 is a schematic diagram of a corrugated container blank manufacturing system 300 for manufacturing the multiwall corrugated container blank 200 of FIG. 2 using a sequentially continuous automated process in accordance with an embodiment of the invention. The term “sequentially continuous automated process,” as used herein, means a process whereby a corrugated container blank is manufactured from at least the point of paper corrugation to the point of flap scoring using a single automated manufacturing sequence. In one aspect of this embodiment, the manufacturing system 300 includes a first single face corrugator 301, a second single face corrugator 302, and a third single face corrugator 303. All three single face corrugators 301-303 produce “single face webs.” A single face web is made by bonding a corrugated paper medium having a selected flute configuration to a flat liner.

The first web 240 is produced by the first single face corrugator 301 using paper received from a medium spool 304 and a liner spool 305. The paper received from the medium spool 304 is corrugated into the corrugated first medium 244 before glue is applied and it is bonded to the flat first paper liner 245 received from the liner spool 305. The second and third single face corrugators 302 and 303 function in a substantially similar manner as the first single face corrugator 301 to produce, respectively, the second web 250 having the corrugated second medium 254 bonded to the second flat liner 255, and the third web 260 having the corrugated third medium 264 bonded to the third flat liner 265. A liner spool 314 provides the liner 266 that will be bonded to the corrugated third medium 264 on the side opposite the third flat liner 265. It will be understood that the first web 240, the second web 250, and the third web 260 are shown in portions of FIG. 3 in an untrimmed raw material state as compared to the finished container blank shown in FIG. 2. Common numbers are used in both figures, however, to associate finished elements with the corresponding raw materials.

When a single face web leaves a single face corrugator, the medium and the liner may not be perfectly aligned along the edges. As a result, webs are generally made slightly oversize so that the edges can be cleaned up when the webs are slit to their final width. Accordingly, after leaving the single face corrugator 301, the first web 240 proceeds through a slitter aligner 320 before being slit to a selected final width in a slitter 322. The slitter aligner 320 of the illustrated embodiment is operably connected to the slitter 322 and aligns the slitter with the first web 240. The slitter aligner 320 locates the edges of the first web 240, determines the centerline of the first web, and transmits this information to the slitter 322. The slitter 322 includes slitting tools (not shown) that are aligned with reference to the centerline of the first web so that each edge of the first web will have approximately the same amount of material removed during the slitting process. After leaving the slitter 322, the first web 240 will be at its final width. In one aspect of this embodiment, this final width corresponds to the first width 243 shown in FIG. 2.

In one aspect of this embodiment, the slitter aligner 320 uses a laser system to locate the edges of the first web 240 and determine the centerline of the first web. In other embodiments, other locating systems can be used. For example, in an alternate embodiment, a camera-sensing system or a photo-eye locating system can be used. One such camera-sensing system includes two cameras located below the first web 240 to establish a reference for controlling the slitter 322. This reference can be the outer edges of the first web 240, the centerline of the first web, or a pre-printed line on the first web. In addition, the slitter aligner 320 can optionally include a web stabilizer to control web position and prevent web weave. Systems for aligning slitters to webs, or, conversely, for aligning webs to slitters, are known to those of ordinary skill in the relevant art. One such system is the TrimMaster system produced by Erhardt+Leimer Inc. of Duncan, S.C., USA.

In another aspect of this embodiment, the manufacturing system 300 further includes a first web aligner 331, a second web aligner 332, and a third web aligner 333, for aligning the first web 240, the second web 250 and the third web 260, respectively, before they enter a glue machine 340. A fourth web aligner 334 is also included for aligning the liner 266 before it enters the glue machine 340. In the illustrated embodiment, the web aligners 331-334 are used to align the first web 240, the second web 250, the third web 260, and the liner 266 along a common centerline, for example, a glue machine centerline, so that the edges of a multiwall corrugated board 341 that leaves the glue machine 340 will ultimately require only minimal trimming to produce uniform edges. In one aspect of this embodiment, the secured web 250, the third web 260, and the liner 266 are wider than the first web 240. In another aspect of this embodiment, the web aligners 331-334 use camera-sensing systems to align their respective webs and liner. For example, one such camera system is the CorrTrac (CorO2) guiding system produced by Erhardt+Leimer Inc. of Duncan, S.C., USA. In other embodiments, other known web alignment systems can be used. For example, in one alternate embodiment the web aligners 331-334 can use photo-eye web alignment systems, and in another alternate embodiment the web aligners can use laser web alignment systems.

The glue machine 340 applies adhesive to the peaks of the first medium 244, the second medium 254, and the third medium 264, and then assembles all three webs and the liner 266 together into the multiwall corrugated board 341. From the glue machine 340 the multiwall corrugated board 341 proceeds to a short press 350 where both heat and pressure are applied to the multiwall corrugated board to cure the adhesive and rigidize the structure.

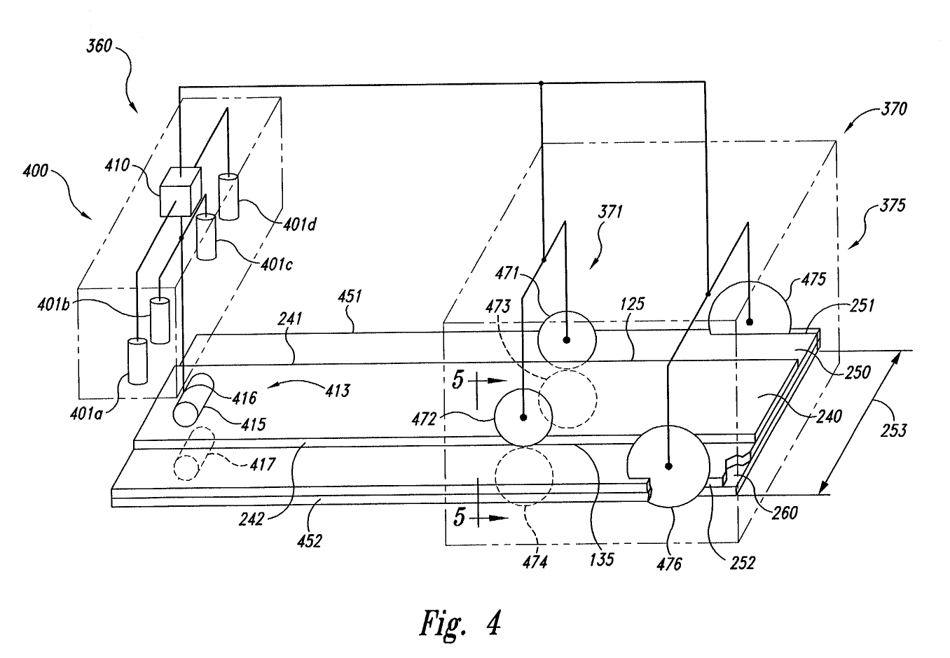

The multiwall corrugated board 341 proceeds from the short press 350 to a slitter/scorer aligner 360 that is operatively connected to a slitter/scorer 370. In one aspect of this embodiment, the slitter/scorer aligner 360 uses a web locating system, such as a camera locating system, to determine the location of at least one edge of one web of the multiwall corrugated board 341 and transmit this information to the slitter/scorer 370. As will be explained in greater detail below with reference to FIG. 4, in one embodiment, this at least one edge can be one or both of the first left or right edges 241 and 242, respectively, of the first web 240. In other embodiments, other edges of other webs can be used.

The slitter/scorer 370 uses the edge location information from the slitter/scorer aligner 360 to position a scoring system 371 and a slitting system 375. The scoring system 371 applies the top score line 125 and the bottom score line 135 to the multiwall corrugated board 341 adjacent to the first left edge 241 and first right edge 242 of the first web 240, respectively. The slitting system 375 accordingly slits the second web 250 and the third web 260 to the second width 253 to produce the second and third left edges 251 and 261 and the second and third right edges 252 and 262, respectively (FIG. 2). In another aspect of this embodiment, the slitter/scorer aligner 360 further includes a stabilizer that stabilizes the multiwall corrugated board 341 as it leaves the slitter/scorer aligner to prevent web weave between the slitter/scorer aligner and the slitter/scorer 370. After leaving the slitter/scorer 370, the multiwall corrugated board 341 proceeds to a cut-off knife 380 that cuts the multiwall corrugated board in selected lengths to create the multiwall corrugated container blank 200 of FIG. 2.

FIG. 4 is a partially schematic isometric view of the slitter/scorer aligner 360 and the slitter/scorer 370 of the manufacturing system 300 of FIG. 3 in accordance with an embodiment of the invention. In one aspect of this embodiment, the slitter/scorer aligner 360 includes a web locating system 400 and a data processor 410. The web locating system 400 of the illustrated embodiment includes a plurality of cameras, such as cameras 401a, 401b, 401c, and 401d, that can be directed toward various features of the multiwall corrugated board 341 for optically determining the lateral location of these features and transmitting this information to the data processor 410 to control the slitter/scorer 370.

For example, in one embodiment the camera 401b is directed toward the first right edge 242 for detecting the corresponding step between the first web 240 and the second web 250, and the camera 401c is directed toward the first left edge 241 for detecting the corresponding step between the first web and the second web. The location of the first right edge 242 and the first left edge 241 is then transmitted to the data processor 410, which uses this information to establish a reference, such as a centerline of the first web 240, for controlling the position of scoring tools 471-474 and slitting tools 475 and 476. In another embodiment, the camera 401a is directed toward a right board edge 452 and the camera 401d is directed toward a left board edge 451, and this information is used to establish a reference, such as a centerline of the multiwall corrugated board 341, for controlling the scoring tools 471-474 and slitting tools 475 and 476. In one aspect of this embodiment, the scoring tools 471-474 can be positioned as a unit relative to the reference, as can the slitting tools 475 and 476. In yet other embodiments, the cameras 401a-401d can be used to locate other selected features of the multiwall corrugated board 341 for control of the slitter/scorer 370, or, alternatively, other locating systems can be employed in other configurations. For example, one such system can include two cameras positioned below the multiwall corrugated board 341 that look upward to locate the right and left board edges 452 and 451, respectively, to establish a control reference, such as a centerline of the multiwall corrugated board 341, for controlling the scoring tools 471-474 and slitting tools 475 and 476.

In another aspect of this embodiment, the slitter/scorer aligner 360 further includes a stabilizer system 413 that is controlled by the data processor 410 for stabilizing the multiwall corrugated board 341 and preventing the multiwall corrugated board from weaving or otherwise deviating from a straight line path between the slitter/scorer aligner 360 and the slitter/scorer 370. In the illustrated embodiment, the stabilizer system 413 includes one or more rollers, such as a no-crush roller 415 positioned above the multiwall corrugated board 341 and a no-crush roller 417 that is positioned below the multiwall corrugated board and is mechanically linked to the no-crush roller 415. The rollers 415 and 417 rollably contact the first web 240 and guide the multiwall corrugated board 341 between the slitter/scorer aligner 360 and the slitter/scorer 370. In one embodiment, a mechanical pivot 416 is incorporated into the stabilizer system 413 and permits angular movement of the no-crush roller 415 in response to digital commands from the data processor 410. These commands are used to provide either a stabilization effect to the multiwall corrugated board 341 in response to slitter movement or a guiding effect in response to a signal from the web locating system 400. In one embodiment, the stabilizer system 413 is a CorrAligner system produced by Erhardt+Leimer Inc. of Duncan, S.C., USA. In other embodiments, other stabilizers can be used.

In another aspect of this embodiment, the slitter/scorer 370 includes the scoring system 371 and the slitting system 375. The scoring system 371 of the illustrated embodiment includes the first male score tool 471 spaced apart from the second male score tool 472 defining a space therebetween to accommodate the first web 240. The first male score tool 471 cooperates with the opposing first female score tool 473 positioned on the backside of the multiwall corrugated board 341 to compress the second web 250 and the third web 260 along the top score line 125. Similarly, the second male score tool 472 cooperates with the opposing second female score tool 474 also positioned on the backside of the multiwall corrugated board 341 to compress the second web 250 and the third web 260 along the bottom score line 135.

In yet another aspect of this embodiment, the slitting system 375 includes the first slitter 475 spaced apart from the second slitter 476 defining the second width 253 therebetween. The first and second slitters 475 and 476 of the illustrated embodiment are rotating blades that slit the multiwall corrugated board 341 to width as it feeds into them. In other embodiments, other sizing devices can be used to trim the multiwall corrugated board 341, or the first and second slitters 475 and 476 can be omitted if finish-sizing of the multiwall corrugated board is not desired.

The slitter/scorer aligner 360 and the slitter/scorer 370 can be used to score the multiwall corrugated board 341 and slit it to width in one embodiment as follows. Cameras 401b and 401c determine the location of the first web 240 and transmit this data to the data processor 410. The data processor 410 positions the scoring system 371 appropriately so that the first male and female score tools 471 and 473 are aligned with the first left edge 241 and the second male and female score tools 472 and 474 are aligned with the first right edge 242. In a similar manner, the cameras 401a and 401d determine the location of the second and third webs 250 and 260 and transmit this data to the data processor 410. The data processor 410 positions the slitting system 375 appropriately to simultaneously cut the second and third webs 250 and 260 to the second width 253 and produce the second left edge 251 and the second right edge 252. In this embodiment, the scoring system 371 and the slitting system 375 move independently of each other based on location data from the slitter/scorer aligner 360.

In one alternate embodiment, the scoring system 371 and the slitting system 375 can be coupled together and move in unison. In this alternate embodiment, the location of the first web 240, as determined by the cameras 401b and 401c, can be used to position both the scoring system 371 and the slitting system 375 such that cameras 401a and 401d can be omitted. In yet another alternate embodiment, the scoring system 371 and the slitting system 375 can be coupled together and appropriately positioned on the multiwall corrugated board 341 using only the location of the first right edge 242 of the first web 240 as determined only by the camera 401b. In this embodiment, cameras 401a, 401c, and 401d are not required.

In a further aspect of the embodiments described above, the first male and female score tools 471 and 473 are fixedly positioned relative to the second male and female score tools 472 and 474, and the two pairs thus move in unison. Similarly, the first slitter 475 is fixedly positioned relative to the second slitter 476. In alternate embodiments, the first male and female score tools 471 and 473 can move independently of the second male and female score tools 472 and 474, and the first slitter 475 can similarly move independently of the second slitter 476.

In other embodiments, the web locating system 400 may include other locating devices instead of the cameras 401a-401d. For example, in one embodiment the web locating system 400 can include a plurality of lasers to locate the respective edges of the multiwall corrugated board 341. In another embodiment, a photo-eye system can locate the respective edges of the multiwall corrugated board 341. Accordingly, other web locating systems and other control schemes for controlling the scoring system 371 can produce the top and bottom score lines 125 and 135 in the multiwall corrugated board 341 without departing from the scope of the present invention.

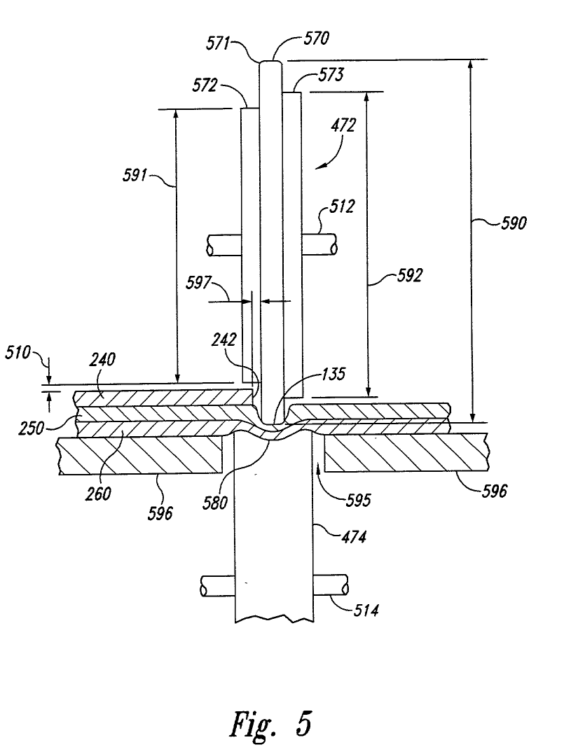

FIG. 5 is an enlarged front cross-sectional view of the cooperating male and female score tools 472 and 474 taken substantially along line 5-5 of FIG. 4 in accordance with an embodiment of the invention. In one aspect of this embodiment, the male score tool 472 is rotatably mounted to a first axle 512 and the female score tool 474 is rotatably mounted to a parallel second axle 514. The female score tool 474 partially extends through an opening 595 in a support structure 596.

In another aspect of this embodiment, the male score tool 472 includes a circular center body 570, a first shoulder 572 concentrically positioned on one side of the center body, and a second shoulder 573 concentrically positioned on the opposite side of the center body. The center body 570 includes a scoring surface 571 having an outer diameter 590 for rotatably compressing the second web 250 and the third web 260 against a concave female scoring surface 580 of the female score tool 474 to produce the bottom score line 135. In an alternate embodiment, the female score tool 474 can be omitted and the second and third webs 250 and 260 can be compressed between the male score tool 472 and the support structure 596 to produce the bottom score line 135. In this alternate embodiment, the opening 595 is omitted so that a portion of the support structure 596 directly opposes the male score tool 472 and supports the second and third webs 250 and 260 while they are being compressed by the male score tool.

The first shoulder 572 and the second shoulder 573 stiffen the male score tool 472 and reduce deflection of the male score tool during scoring. The first shoulder 572 has a first diameter 591 and the second shoulder 573 has a larger second diameter 592. Both the first diameter 591 and the second diameter 592 are smaller than the outer diameter 590. In one aspect of this embodiment, the first diameter 591 is sufficiently smaller than the outer diameter 590 so that the first shoulder 572 will not crush the adjacent first right edge 242 of the first web 240 when the center body 570 is producing the bottom score line 135. Accordingly, the first diameter 591 provides a clearance 510 between the first shoulder portion 572 and the first web 240. In the illustrated embodiment, the first diameter 591 is smaller than the second diameter 592. However, in an alternate embodiment, the first and second diameters 591 and 592 can be at least approximately equal. In another aspect of this embodiment, the center body 570 is offset a distance 597 from the first right edge 242 so that when the second and third webs 250 and 260 are folded inwardly along the bottom score line 135 they will not crush the first right edge. In one embodiment, the distance 597 is between 0.03 and 0.10 inch, and in a particular aspect of this embodiment the distance 597 is 0.05 inch. In other embodiments, other offset dimensions can be used.

From the foregoing, it will be appreciated that, although specific embodiments of the invention have been described herein for purposes of illustration, various modifications may be made without deviating from the spirit and scope of the invention. For example, as explained above, embodiments of the present invention can be used in accordance with this disclosure to produce other multiwall corrugated container blanks, such as multiwall corrugated container blanks having body portions and flap portions of different thicknesses than discussed here. Accordingly, the invention is not limited, except as by the appended claims.

We claim:

1. A method for constructing a multiwall corrugated container blank, the multiwall corrugated container blank including a body portion having a first wall thickness and a flap portion having a second wall thickness, wherein the first wall thickness is greater than the second wall thickness, the method comprising:
producing a first web having a first left edge, a parallel first right edge, and a first width between the first left edge and the first right edge, the first web including a corrugated first medium bonded to a flat first liner;
producing a second web having a second left edge, a parallel second right edge, and a second width between the second left edge and the second right edge greater than the first width, the second web including a corrugated second medium bonded to a flat second liner;
bonding the first medium of the first web to the second liner of the second web to at least partially define the body portion and the flap portion of the multiwall corrugated container blank;
determining a location of at least one of the first left edge or the first right edge of the first web;
positioning a male score tool and a cooperating female score tool adjacent to at least one of the first left edge or the first right edge based on the determined location of the first left edge or the first right edge; and
scoring the second web adjacent to at least one of the first left edge or the first right edge with the positioned male and female score tools without scoring the first web, wherein the foregoing steps of producing the first and second webs, bonding the first medium of the first web to the second liner of the second web, determining the location of the at least one of the first left edge or the first right edge of the first web, positioning the male score tool and the cooperating female score tool, and scoring the second web are performed in a sequentially continuous automated process.

2. The method of claim 1 wherein the flap portion is a first flap portion, and wherein the multiwall corrugated container blank further includes a second flap portion, further wherein:
bonding the first medium of the first web to the second liner of the second web at least partially defines the body portion and the first and second flap portions of the multiwall corrugated container blank;
positioning a male score tool and a cooperating female score tool adjacent to at least one of the first left edge or the first right edge includes positioning a first male score tool and a first cooperating female score tool adjacent to the first left edge and positioning a second male score tool and a second cooperating female score tool adjacent to the first right edge; and
scoring the second web includes scoring the second web adjacent to the first left edge with the first male score tool and the first female score tool and scoring the second web adjacent to the first right edge with the second male score tool and the second female score tool.

3. The method of claim 1 wherein the flap portion is a first flap portion, and wherein the multiwall corrugated container blank further includes a second flap portion, further wherein:
bonding the first medium of the first web to the second liner of the second web at least partially defines the body portion and the first and second flap portions of the multiwall corrugated container blank so that the first flap portion is at least substantially the same width as the second flap portion;
positioning a male score tool and a cooperating female score tool adjacent to at least one of the first left edge or the first right edge includes positioning a first male score tool and a first cooperating female score tool adjacent to the first left edge and positioning a second male score tool and a second cooperating female score tool adjacent to the first right edge; and
scoring the second web includes scoring the second web adjacent to the first left edge with the first male score tool and the first female score tool and scoring the second web adjacent to the first right edge with the second male score tool and the second female score tool.

4. The method of claim 1 wherein producing the first web includes bonding the first medium to the first liner and slitting the first medium and the first liner to produce the first left edge and the parallel first right edge.

5. The method of claim 1 wherein bonding the first medium of the first web to the second liner of the second web at least partially defines the first wall thickness of the body portion and the second wall thickness of the flap portion, wherein the first wall thickness is triple wall and the second wall thickness is double wall.

6. The method of claim 1 wherein bonding the first medium of the first web to the second liner of the second web at least partially defines the first wall thickness of the body portion and the second wall thickness of the flap portion, wherein the first wall thickness is double wall and the second wall thickness is single wall.

7. The method of claim 1 wherein scoring the second web adjacent to at least one of the first left edge or the first right edge includes scoring the second web along a first score line offset from the first left edge by a distance of up to about 0.25 inch and scoring the second web along a second score line offset from the first right edge by a distance of up to about 0.25 inch.

8. The method of claim 1, further comprising:
producing a third web having a third left edge and a parallel third right edge at least approximately defining the second width between the third left edge and the third right edge, the third web including a corrugated third medium bonded to a flat third liner; and
bonding the second medium of the second web to the third liner of the third web, wherein scoring the second web comprises scoring the second and third webs adjacent to at least one of the first left edge or the first right edge with the positioned male and female score tools.

9. The method of claim 1 wherein determining a location of at least one of the first left edge or the first right edge includes optically determining the location of the first left edge using at least one camera.

10. The method of claim 1 wherein the sequentially continuous automated process is a process whereby a corrugated container blank is manufactured from at least a point of paper corrugation to a point of flap scoring using a series of automated processes in a single production line.

11. An automated method for constructing a multiwall corrugated container blank, the multiwall corrugated container blank having a body portion and a flap portion with different wall thicknesses, the method comprising:
producing a first web having a first edge, a second edge, and a first width between the first edge and the second edge, the first web including a corrugated first medium bonded to a flat first liner;
producing a second web having a third edge, a fourth edge, and a second width between the third edge and the fourth edge, the second width being greater than the first width, the second web including a corrugated second medium bonded to a flat second liner;
bonding the first web to the second web to at least partially define the body portion and the flap portion of the multiwall corrugated container blank; and
scoring the second web adjacent to at least one of the first edge and the second edge of the first web without scoring the first web.

12. The method of claim 11 wherein bonding the first web to the second web at least partially defines a first wall thickness of the body portion and a second wall thickness of the flap portion, wherein the first wall thickness is triple wall and the second wall thickness is double wall.

13. The method of claim 11 wherein bonding the first web to the second web at least partially defines a first wall thickness of the body portion and a second wall thickness of the flap portion, wherein the first wall thickness is double wall and the second wall thickness is single wall.

14. The method of claim 11 wherein producing the first web includes bonding the first medium to the first liner and slitting the first medium and the first liner to produce the first edge and the second edge.

15. The method of claim 11 wherein scoring the second web adjacent to at least one of the first edge and the second edge includes scoring the second web along a first score line offset from the first edge by a distance of up to about 0.25 inch and scoring the second web along a second score line offset from the second edge by a distance of up to about 0.25 inch.

16. The method of claim 11, further comprising:
determining a location of at least one of the first edge and the second edge; and
positioning a male score tool adjacent to at least one of the first edge and the second edge based on the determined location of the at least one of the first edge and the second edge, wherein scoring the second web comprises scoring the second web adjacent to at least one of the first edge and the second edge with the positioned male score tool.

17. The method of claim 11, further comprising:
determining a location of at least one of the first edge and the second edge; and
positioning a male score tool and a cooperating female score tool adjacent to at least one of the first edge and the second edge based on the determined location of the at least one of the first edge and the second edge, wherein scoring the second web includes scoring the second web adjacent to at least one of the first edge and the second edge with the positioned male and female score tools.

18. The method of claim 11 wherein the flap portion is a first flap portion, wherein the corrugated container blank further includes a second flap portion, wherein bonding the first web to the second web at least partially defines the body portion and the first and second flap portions, and wherein the method further comprises positioning a first male score tool adjacent to the first edge and a second male score tool adjacent to the second edge, wherein scoring the second web includes scoring the second web adjacent to the first edge with the positioned first male score tool and scoring the second web adjacent to the second edge with the positioned second male score tool.

19. The method of claim 11, further comprising:
optically determining a location of at least one of the first edge and the second edge of the first web using at least one camera; and
positioning a male score tool adjacent to at least one of the first edge and the second edge based on the optically determined location of the at least one of the first edge and the second edge, wherein scoring the second web includes scoring the second web adjacent to at least one of the first edge and the second edge with the positioned male score tool.

20. The method of claim 11 further comprising:
producing a third web having a fifth edge and a sixth edge at least approximately defining the second width between the fifth edge and the sixth edge, the third web including a corrugated third medium bonded to a flat third liner; and
bonding the second web to the third web, wherein scoring the second web includes scoring the second and third webs adjacent to at least one of the first edge and the second edge.

21. A rotatable score tool for producing a score line on a multiwall corrugated container blank, the multiwall corrugated container blank including a body portion having a first wall thickness and a flap portion having a second wall thickness, wherein the first wall thickness is greater than the second wall thickness, and wherein the score line is produced on the flap portion adjacent to the body portion, the score tool comprising:
a circular center body having a scoring surface disposed between a first side facing a first direction and a second side facing an opposite direction, the scoring surface having an outer diameter;
a first shoulder concentrically projecting from the first side of the center body, the first shoulder having a first diameter; and
a second shoulder concentrically projecting from the second side of the center body, the second shoulder having a second diameter that is less than the outer diameter of the scoring surface but greater than the first diameter of the first shoulder.

22. The rotatable score tool of claim 21 wherein:
the outer diameter is between about 8.0 and about 12.0 inches;
the first diameter is between about 6.0 and about 11.0 inches; and
the second diameter is between about 6.5 and about 11.5 inches.

23. The rotatable score tool of claim 21 wherein the center body, the first shoulder, and the second shoulder comprise a single piece of metal.

24. A system for manufacturing a multiwall corrugated container blank in a sequentially continuous automated process, the multiwall corrugated container blank including a body portion having a first wall thickness and a flap portion having a second wall thickness, wherein the first wall thickness is greater than the second wall thickness, the system comprising:
a first single face corrugator configured to form a first web having a corrugated first medium bonded to a flat first liner, the first web including a first left edge, a first right edge, and a first width between the first left edge and the first right edge;
a second single face corrugator configured to form a second web having a corrugated second medium bonded to a flat second liner, the second web including a second left edge, a second right edge, and a second width between the second left edge and the second right edge, the second width being greater than the first width;
a bonding machine positioned to receive the first web from the first single face corrugator and the second web from the second single face corrugator, the bonding machine configured to bond the first medium of the first web to the second liner of the second web to at least partially define the body portion and the flap portion of the multiwall corrugated container blank;
an alignment system positioned to receive the bonded first and second webs from the bonding machine, the alignment system configured to and determine the location of at least one of the first left edge and the first right edge of the first web;
a scoring system positioned to receive the bonded first and second webs from the alignment system, the scoring system having at least one male score tool and at least one cooperating female score tool, the scoring system configured to position the male and female score tools adjacent to at least one of the first left edge and the first right edge based on the determined location of the at least one edge; and
a communication link operatively coupling the alignment system to the scoring system, the communication link configured to communicate the determined location of the at least one edge from the alignment system to the scoring system.

25. The system of claim 24, further comprising:
a first slitting system positioned to receive the first web from the first single face corrugator before the first web proceeds to the bonding machine, the first slitting system configured to slit the first web to produce the first left edge and the first right edge; and
a second slitting system positioned to receive the bonded first and second webs from the scoring system, the second slitting system configured to slit the second web to produce the second left edge and the second right edge.

26. The system of claim 24, further comprising a short press positioned to receive the first and second webs from the bonding machine before the first and second webs proceed to the alignment system, the short press configured to apply heat and pressure to the first and second webs to bond the first web to the second web.

27. The system of claim 24 wherein the alignment system includes at least one camera for optically determining the location of the at least one of the first left edge and the first right edge of the first web.

28. A system for manufacturing a multiwall corrugated container blank having a first web bonded to a second web to define a body portion and a flap portion with different wall thicknesses, the first web having a first edge, a second edge, and a first width between the first edge and the second edge, the second web having a third edge, a fourth edge, and a second width between the third edge and the fourth edge, the second width being greater than the first width, the system comprising:
an aligner having a web locating system configured to automatically determine first web location information, the first web location information including the location of at least one of the first edge and the second edge;
a data processor operatively coupled to the web locating system to receive the first web location information from the web locating system; and
a scoring system positioned to receive the first and second webs from the aligner, the scoring system having at least one score tool for scoring the second web adjacent to at least one of the first edge and the second edge, the scoring system being operatively coupled to the data processor for selectively receiving the first web location information from the data processor and positioning the at least one score tool based on the received first web location information.

29. The system of claim 28, further comprising a slitting system having at least one slitting tool for slitting the second web to produce at least one of the third edge and the fourth edge, the slitting system being operatively coupled to the data processor for selectively receiving the first web location information from the data processor and positioning the at least one slitting tool based on the received first web location information.

30. The system of claim 28 wherein the web locating system includes at least one camera for optically determining the first web location information.

31. The system of claim 28 wherein the first web of the multiwall corrugated container blank includes a corrugated first medium bonded to a flat first liner and the second web includes a corrugated second medium bonded to a flat second liner, the corrugated first medium of the first web being bonded to the flat second liner of the second web.

32. The system of claim 28 wherein the at least one score tool of the scoring system is a rotatable score tool comprising:
a circular center body having a scoring surface disposed between a first side facing a first direction and a second side facing an opposite direction, the scoring surface having an outer diameter;
a first shoulder concentrically projecting from the first side of the center body, the first shoulder having a first diameter and being positionable toward the body portion of the multiwall corrugated container blank; and
a second shoulder concentrically projecting from the second side of the center body, the second shoulder having a second diameter that is less than the outer diameter of the scoring surface but greater than the first diameter of the first shoulder.

33. The system of claim 28 wherein the aligner further comprises a stabilizer for stabilizing the first and second webs as they move between the aligner and the scoring system.

34. A system for constructing a multiwall corrugated container blank, the multiwall corrugated container blank having a body portion and a flap portion with different wall thicknesses, the system comprising:
means for producing a first web having a first edge, a second edge, and a first width between the first edge and the second edge, the first web including a corrugated first medium bonded to a flat first liner;
means for producing a second web having a third edge, a fourth edge, and a second width between the third edge and the fourth edge, the second width being greater than the first width, the second web including a corrugated second medium bonded to a flat second liner;
means for bonding the first web to the second web to at least partially define the body portion and the flap portion of the multiwall corrugated container blank; and
means for scoring the second web adjacent to at least one of the first edge and the second edge of the first web without scoring the first web.

35. The system of claim 34 wherein the means for bonding the first web to the second web is a means for at least partially defining a triple wall body portion and a double wall flap portion.

36. The system of claim 34 wherein the means for bonding the first web to the second web is a means for at least partially defining a double wall body portion and a single wall flap portion.

37. The system of claim 34 wherein the means for producing the first web includes a means for bonding the first medium to the first liner and slitting the first medium and the first liner to produce the first edge and the second edge.

38. The system of claim 34 wherein the means for scoring the second web adjacent to at least one of the first edge and the second edge includes a means for scoring the second web along a first score line offset from the first edge by a distance of up to about 0.25 inch and scoring the second web along a second score line offset from the second edge by a distance of up to about 0.25 inch.

39. The system of claim 34, further comprising:
means for determining a location of at least one of the first edge and the second edge; and
means for positioning a male score tool adjacent to at least one of the first edge and the second edge based on the determined location of the at least one of the first edge and the second edge, wherein scoring the second web includes scoring the second web adjacent to at least one of the first edge and the second edge with the positioned male score tool.

40. The system of claim 34, further comprising:
means for determining a location of at least one of the first edge and the second edge; and
means for positioning a male score tool and a cooperating female score tool adjacent to at least one of the first edge and the second edge based on the determined location of the at least one of the first edge and the second edge, wherein scoring the second web includes scoring the second web adjacent to at least one of the first edge and the second edge with the positioned male and female score tools.

41. The system of claim 34, further comprising:
means for optically determining a location of at least one of the first edge and the second edge using at least one camera; and
means for positioning a male score tool adjacent to at least one of the first edge and the second edge based on the optically determined location of the at least one of the first edge and the second edge, wherein scoring the second web includes scoring the second web adjacent to at least one of the first edge and the second edge with the positioned male score tool.

42. The system of claim 34, further comprising:
means for producing a third web having a fifth edge and a sixth edge at least approximately defining the second width between the fifth edge and the sixth edge, the third web including a corrugated third medium bonded to a flat third liner; and
means for bonding the second web to the third web, wherein scoring the second web includes scoring the second and third webs adjacent to at least one of the first edge and the second edge.
